(19) United States
(12) Patent Application Publication
(10) Pub. No.: US 2026/0235190 A1
(43) Pub. Date: Aug. 13, 2026

(54) ECCENTRIC OSCILLATION-TYPE GEAR DEVICE

(71) Applicant: SUMITOMO HEAVY INDUSTRIES, LTD., Tokyo (JP)

(72) Inventor: Teijiro YAMANAKA, Yokosuka-shi (JP)

(21) Appl. No.: 19/639,343

(22) Filed: Apr. 6, 2026

Related U.S. Application Data
(63) Continuation of application No. PCT/JP2024/035746, filed on Oct. 7, 2024.

(30) Foreign Application Priority Data
Oct. 19, 2023 (JP) 2023-180537

(51) Int. Cl. F16H 1/32

(52) U.S. Cl. CPC F16H 1/32; F16H 2001/325

(57) ABSTRACT

An eccentric oscillation-type gear device includes eccentric bodies, a first external gear and a second external gear that oscillate by predetermined amounts of eccentricity due to the eccentric bodies, a carrier provided on an axially opposite side of the first external gear from the second external gear, and a plurality of inner pins integrated by the carrier and passing through the first external gear and the second external gear, in which an amount of eccentricity of a second eccentric body corresponding to the second external gear is greater than an amount of eccentricity of a first eccentric body corresponding to the first external gear.

### CROSS-REFERENCE TO RELATED APPLICATIONS

This is a bypass continuation of International PCT Application No. PCT/JP2024/035746, filed on October 7, 2024, which claims priority to Japanese Patent Application No. 2023-180537, filed on October 19, 2023, which are incorporated by reference herein in their entirety.

### BACKGROUND

### TECHNICAL FIELD

A certain embodiment of the present invention relates to an eccentric oscillation-type gear device.

### DESCRIPTION OF RELATED ART

A speed reducer is known that reduces the speed of rotation input to an input shaft and that outputs the speed-reduced rotation. For example, the related art discloses a speed reducer including an external gear, an internal gear, a plurality of carrier pins that rotate while being in contact with carrier pin holes of the external gear, and a carrier including an output shaft that outputs rotation of an axial rotation component of the external gear via the carrier pins. In this speed reducer, the carrier includes a support portion that connects the plurality of carrier pins, one end of each carrier pin is fixed to the support portion, and the carrier pins are cantilever-supported by the support portion.

### SUMMARY

According to an embodiment of the present invention, there is provided an eccentric oscillation-type gear device including: eccentric bodies; a first external gear and a second external gear that oscillate by predetermined amounts of eccentricity due to the eccentric bodies; a carrier provided on an axially opposite side of the first external gear from the second external gear; and a plurality of inner pins integrated by the carrier and passing through the first external gear and the second external gear, in which an amount of eccentricity of a second eccentric body corresponding to the second external gear is greater than an amount of eccentricity of a first eccentric body corresponding to the first external gear.

### BRIEF DESCRIPTION OF THE DRAWINGS

FIG. 1 is a sectional side view showing an eccentric oscillation-type gear device according to an embodiment.

FIG. 2 is a front view schematically showing the eccentric oscillation-type gear device of FIG. 1.

FIG. 3 is a cross-sectional view showing, in an enlarged manner, a periphery of an eccentric body of the eccentric oscillation-type gear device of FIG. 1.

### DETAILED DESCRIPTION

The inventor has obtained the following new insight regarding the eccentric oscillation-type gear device. In the speed reducer disclosed in the related art, the carrier pins are cantilever-supported by the carrier on an output side. Root portions of the carrier pins on a side closer to the carrier that supports the carrier pins have higher stiffness than tip portions on a side farther from the carrier. Accordingly, it is considered that the output torque generated in the carrier is not equally shared between the external gear on the output side closer to the carrier and the external gear on an input side farther from the carrier, and that the influences on respective sliding portions of the external gears are not uniform.

From these considerations, the inventor has come to recognize that, in the speed reducer disclosed in the related art, it is important to further improve, for example, configurations relating to the influence of a load received from the output side on the gear.

The present disclosure has been made in view of such issues, and it is desirable to provide an eccentric oscillation-type gear device capable of improving the influence of the load received from the output side on the sliding portions of the gears.

Any combinations of the above components, and substitutions in which components and expressions of the present disclosure are interchangeably replaced among methods, systems, and the like, are also effective as aspects of the present disclosure.

According to the present disclosure, it is possible to provide an eccentric oscillation-type gear device capable of improving the influence of the load received from the output side on the sliding portions of the gears.

Hereinafter, the present disclosure will be described with reference to the drawings based on preferred embodiments. In the embodiments and modification examples, identical or equivalent components and members are denoted by the same reference numerals, and redundant description will be omitted as appropriate. Further, the dimensions of members in the respective drawings are enlarged or reduced as appropriate for ease of understanding. Furthermore, in the respective drawings, some members that are not important for describing the embodiments are omitted from illustration.

In addition, terms including ordinal numbers such as “first” and “second” are used to describe various components, but such terms are used only for the purpose of distinguishing one component from another, and do not limit the components.

### EMBODIMENT

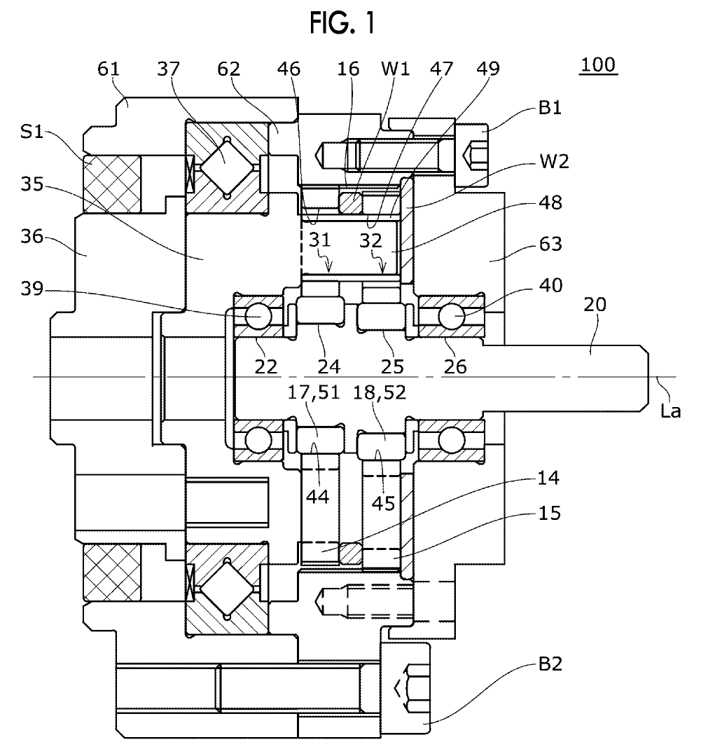

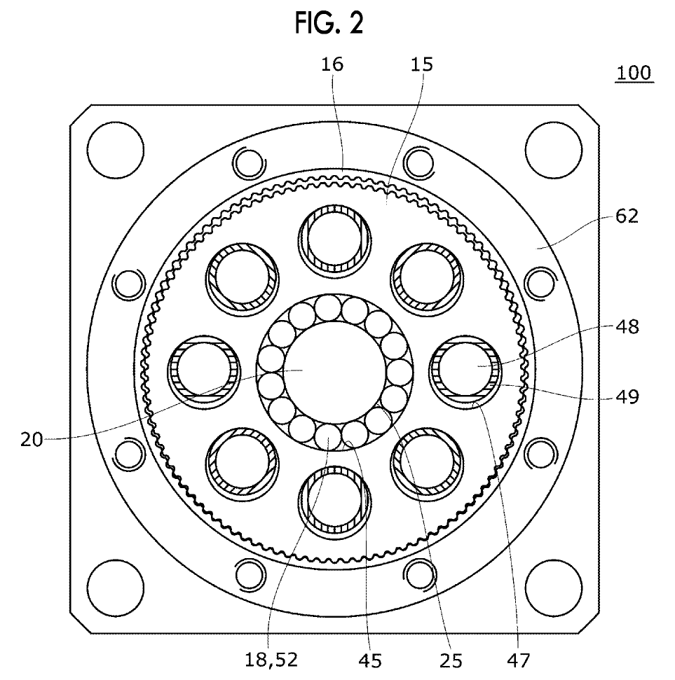

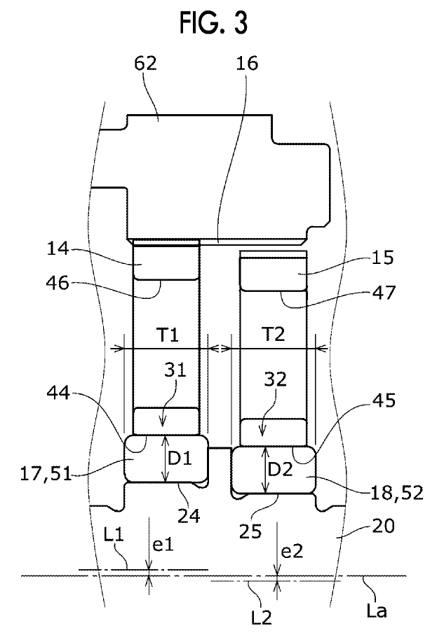

First, an overall configuration of an eccentric oscillation-type gear device 100 (hereinafter, may be referred to as a “gear device 100”) according to the embodiment will be described with reference to FIGS. 1 to 3. FIG. 1 is a cross-sectional view in a side view showing an example of the gear device 100. FIG. 2 is a front view of the gear device 100, with the interior exposed. FIG. 3 is a cross-sectional view showing, in an enlarged manner, a periphery of eccentric bodies 31 and 32.

The gear device 100 mainly includes a crankshaft 20, external gears 14 and 15, an internal gear 16, eccentric-body bearings 17 and 18, the eccentric bodies 31 and 32, a carrier 35, an output flange 36, a main bearing 37, crankshaft bearings 39 and 40, internal pins 48, casings 61 and 62, and an input cover 63. Hereinafter, a direction along a center axis La of the internal gear 16 will be referred to as an “axial direction”, and a circumferential direction and a radial direction of a circle centered on the center axis La will be referred to as a “circumferential direction” and a “radial direction”, respectively. Further, a side (left side in the drawing) on which the carrier 35 is provided with respect to the external gears 14 and 15 in the axial direction will be referred to as an output side, and a side (right side in the drawing) opposite to the output side will be referred to as an input side.

The gear device 100 includes a reduction mechanism that reduces the speed of rotation input from a power source such as a motor (not shown) to the crankshaft 20 and that outputs the speed-reduced rotation from the output flange 36. The reduction mechanism is not limited as long as the input rotation can be output after the speed thereof is reduced, and various mechanisms can be used. The gear device 100 according to the embodiment is an eccentric oscillation-type gear device that causes the external gears meshing with the internal gear to oscillate, thereby generating axial rotation of the external gears and outputting a generated axial rotation component from the output flange 36 to a driven member. The gear device 100 according to the embodiment is of a center-crank type in which a center axis of the crankshaft 20 is provided on the same coaxial line as the center axis La of the internal gear.

The crankshaft 20 is a shaft body extending from the input side to the output side in the axial direction, and is rotated around a rotation center line La by the input rotation. On an outer periphery of the crankshaft 20, a first shaft portion 22, a first eccentric portion 24, a second eccentric portion 25, and a second shaft portion 26 are provided in order from the output side to the input side. The first shaft portion 22 and the second shaft portion 26 support inner rings of the crankshaft bearings 39 and 40. The first eccentric portion 24 and the second eccentric portion 25 are cylindrical portions having a larger diameter than the first shaft portion 22 and are eccentric, as will be described later. The second shaft portion 26 is a cylindrical portion having the same diameter as the first shaft portion 22.

The first shaft portion 22 on the output side of the crankshaft 20 is supported by the carrier 35 via a first crankshaft bearing 39. The second shaft portion 26 on the input side of the crankshaft 20 is supported by the input cover 63 via a second crankshaft bearing 40. That is, the crankshaft 20 is rotatably supported by the carrier 35 and the input cover 63. The input cover 63 is connected to the input side of the casings 61 and 62, which will be described later, by a bolt B1 and covers the input side of the reduction mechanism.

The first crankshaft bearing 39 is disposed between the carrier 35 and the shaft portion 22 of the crankshaft 20, and a second crankshaft bearing 40 is disposed between the input cover 63 and the shaft portion 26 of the crankshaft 20. Various known bearing mechanisms can be adopted as the crankshaft bearings 39 and 40. In the present example, the crankshaft bearings 39 and 40 are ball bearings having spherical rolling elements.

The crankshaft 20 is an eccentric body shaft having a plurality of eccentric portions 24 and 25 for oscillating the external gears 14 and 15, and may be referred to as an input shaft. An axial center of the eccentric portions 24 and 25 is eccentric with respect to the rotation center line (same position as the center axis La) of the crankshaft 20. In the embodiment, two eccentric portions 24 and 25 are provided, and the eccentric phases of the adjacent eccentric portions 24 and 25 are shifted by 180°. The eccentric portions 24 and 25 constitute the eccentric bodies 31 and 32, which will be described later. The eccentric-body bearings 17 and 18 are disposed on outer peripheries of the eccentric portions 24 and 25. The eccentric-body bearings 17 and 18 of the present example are roller bearings having a plurality of cylindrical rolling elements 51 and 52. In FIG. 3, reference numerals D1 and D2 indicate diameters of the rolling elements 51 and 52 (the outer diameters of the cross sections perpendicular to the axial direction of the rolling elements), and reference numerals T1 and T2 indicate axial lengths of the rolling elements 51 and 52.

The eccentric bodies 31 and 32 include a first eccentric body 31 that oscillates the first external gear 14 by a predetermined amount of eccentricity e1, and a second eccentric body 32 that oscillates the second external gear 15 by a predetermined amount of eccentricity e2. In the present specification, a distance between a predetermined rotation axis and a center axis of the external gear will be referred to as an amount of eccentricity of the eccentric body. In the example of FIG. 3, a distance e1 between the center axis La of the internal gear 16 and a rotation center line L1 of the first external gear 14 is referred to as the amount of eccentricity e1 of the first eccentric body 31, and a distance e2 between the center axis La and a rotation center line L2 of the second external gear 15 is referred to as the amount of eccentricity e2 of the second eccentric body 32. The amount of eccentricity may be a distance between a rotation center axis of the carrier and the center axis of the external gear.

In the embodiment, the eccentric bodies 31 and 32 have the eccentric portions 24 and 25 formed on the outer periphery of the crankshaft 20, which is a shaft body, and the eccentric-body bearings 17 and 18 disposed on the outer peripheries of the eccentric portions 24 and 25. That is, the first eccentric body 31 has the first eccentric portion 24 and a first eccentric-body bearing 17 disposed on the outer periphery of the first eccentric portion 24. The second eccentric body 32 has the second eccentric portion 25 and a second eccentric-body bearing 18 disposed on the outer periphery of the second eccentric portion 25. Therefore, the amount of eccentricity e1 of the first eccentric body 31 can be set by the amount of eccentricity of the first eccentric portion 24 and the diameter D1 of the rolling element of the first eccentric-body bearing 17, and the amount of eccentricity e2 of the second eccentric body 32 can be set by the amount of eccentricity of the second eccentric portion 25 and the diameter D2 of the rolling element of the second eccentric-body bearing 18. The diameters D1 and D2 are the diameters of the rolling elements as viewed in the axial direction.

The external gears 14 and 15 are oscillatably incorporated on the outer peripheries of the eccentric portions 24 and 25 via the eccentric-body bearings 17 and 18. The external gears 14 and 15 each internally mesh with the internal gear 16 while oscillating. Wavy teeth are formed on outer peripheries of the external gears 14 and 15, and, as these teeth move while being in contact with the internal gear 16, the external gears 14 and 15 are enabled to oscillate within a plane normal to the center axis. An annular spacer W1 is disposed between the external gears 14 and 15 to maintain an axial spacing between the external gears 14 and 15 within a predetermined range. An annular end washer W2 that regulates the axial positions of the external gears 14 and 15 is disposed between the external gear 15 and the input cover 63. An outer edge of the end washer W2 is interposed between an end surface of a second casing 62 on the input side and the input cover 63.

The internal gear 16 meshes with the external gears 14 and 15. The internal gear 16 of the embodiment is composed of internal teeth integrally provided on an inner peripheral side of the second casing 62. The number of internal teeth of the internal gear 16 is slightly greater (in the present example, by two) than the number of external teeth of the external gears 14 and 15.

A plurality of inner pin holes 46 and 47 are formed in the external gears 14 and 15 at positions offset from axial centers thereof. The inner pins 48 pass through the inner pin holes 46 and 47. A cylindrical inner roller 49 is disposed on an outer periphery of the inner pin 48. The inner roller 49 functions as a sliding promoting member for smoothing the sliding with the inner pin holes 46 and 47. An outer diameter of the inner roller 49 is smaller than an inner diameter of the inner pin holes 46 and 47 by an amount equivalent to twice the amount of eccentricity.

A clearance serving as play for absorbing an oscillation component of the external gears 14 and 15 is provided between the inner rollers 49 and the inner pins 48, and the inner pins 48 are always in contact, via the inner rollers 49, with a portion of the inner pin holes 46 and 47. The inner pins 48 revolve around an axial center of the crankshaft 20 in synchronization with an axial rotation component of the external gears 14 and 15, thereby rotating the carrier 35 around the axial center of the crankshaft 20. The inner pins 48 contribute to the transmission of power between the carrier 35 and the external gears 14 and 15.

The casings 61 and 62 have a tubular shape constituting an outer shell of the gear device 100. The casings 61 and 62 include a first casing 61 and a second casing 62 connected to the input side of the first casing 61. The first casing 61 mainly surrounds the main bearing 37 and an oil seal S1. The internal gear 16 is provided on an inner peripheral surface of the second casing 62. The first casing 61 and the second casing 62 are connected to each other by a bolt B2.

The carrier 35 has a hollow circular shape. The carrier 35 is disposed on a side portion of the external gears 14 and 15 on the output side. The input cover 63 is disposed on a side portion of the external gears 14 and 15 on the input side. The carrier 35 is rotatably supported by the casings 61 and 62 via the main bearing 37. The carrier 35 rotatably supports the output side of the crankshaft 20 via the first crankshaft bearing 39. The input cover 63 rotatably supports the input side of the crankshaft 20 via the second crankshaft bearing 40.

The output flange 36 is a hollow circular member connected to the output side of the carrier 35. The output flange 36 is surrounded by the first casing 61, and the oil seal S1 is disposed between the output flange 36 and the first casing 61. The rotation input to the crankshaft 20 is speed-reduced by the reduction mechanism and is output from the output flange 36 via the carrier 35.

The main bearing 37 is disposed between the first casing 61 and the carrier 35. Various known bearing mechanisms can be adopted as the main bearing 37, and the main bearing 37 in the present example is a cross-roller bearing.

The inner pins 48 are rod-shaped members extending in the axial direction from the input side of the carrier 35 toward the input cover 63, and a plurality of inner pins 48 are provided at predetermined intervals in the circumferential direction. The plurality of inner pins 48 pass through the inner pin holes 46 and 47 of the first external gear 14 and the second external gear 15. The plurality of inner pins 48 are integrated by the carrier 35. The configuration in which the inner pins 48 are integrated includes a configuration in which the carrier 35 and the plurality of inner pins 48 are integrally formed from a single piece of material, and a configuration in which the inner pins 48 are formed separately from the carrier 35 and are connected to the carrier 35. A tip end of the inner pin 48 faces the end washer W2 in a state of being in contact with or not in contact with the end washer W2.

The speed-reduction operation of the gear device 100 will be described. In a case where the rotational power is transmitted to the crankshaft 20, the eccentric bodies 31 and 32 constituted by the eccentric portions 24 and 25 of the crankshaft 20 and the eccentric-body bearings 17 and 18 rotate around the rotation center line passing through the crankshaft 20, and the external gears 14 and 15 oscillate by means of the eccentric bodies 31 and 32. In this case, the external gears 14 and 15 oscillate such that the rotation center lines L1 and L2 of the external gears 14 and 15 rotate around the center axis La of the internal gear 16. In a case where the external gears 14 and 15 oscillate, the meshing positions of the external gears 14 and 15 and the internal teeth of the internal gear 16 are sequentially shifted. As a result, each time the crankshaft 20 rotates once, one of the external gears 14 and 15 and the internal gear 16 rotates by an amount corresponding to the difference between the number of teeth of the external gears 14 and 15 and the number of teeth of the internal gear 16. In the embodiment, the external gears 14 and 15 rotate, and the speed-reduced rotation is output from the output flange 36 via the carrier 35. The driven member connected to the output flange 36 is rotationally driven by the rotation of the output flange 36.

Next, the deflection of the inner pin of the gear device and the influence thereof will be described. In the gear device, the output torque is transmitted to the carrier via the inner pins by the oscillation of the external gears. The stiffness of a portion of the inner pin farther from a support end is lower than the stiffness of a portion near the support end. In a case where the external gear oscillates, a load is applied to the inner pin in contact with the external gears, and the inner pin deflects, thereby yielding. In a case where the inner pin deflects, the torque transmission function of the inner pin is reduced in accordance with the amount of deflection. In this case, among the plurality of external gears, the gear corresponding to the portion in which the inner pin deflects less bears a greater torque than the other gears, and damage to each sliding portion of the gear occurs earlier than the other gears.

In a case where the inner pin is cantilever-supported, the deflection of the inner pin on a base end side of the inner pin is smaller than the deflection of the inner pin on a tip end side, and the external gear closer to the base end side has a greater torque share ratio than the external gear closer to the tip end side. Accordingly, relatively large stress is applied to the respective sliding portions of the external gear on the base end side and the internal gear corresponding thereto, and deterioration progresses earlier than in the other sliding portions. In a case where the inner pin is supported at both ends, the deflection of a central portion away from both support ends is greater than the deflection in the vicinity of the support end. For example, when three external gears are provided, the two external gears near the support end have a greater torque share ratio than the central external gear, such that a relatively large torque is applied thereto, and damage at the respective sliding portions of these gears occurs earlier than in the others.

In addition, the load received from the output side is applied to the carrier as the external torque. The external torque is transmitted to the external gear via the inner pin. The influence of the external torque is the same as the influence of the output torque, and the gear corresponding to the portion in which the inner pin deflects less receives a greater torque than the other gears, and damage to each sliding portion occurs earlier. From these findings, the inventor has come to recognize that it is important to further improve the configuration related to the influence of the load received from the output side on the gear.

In view of these findings, in the gear device 100 according to the embodiment, the amount of eccentricity e2 of the second eccentric body 32 corresponding to the second external gear 15 is set to be greater than the amount of eccentricity e1 of the first eccentric body 31 corresponding to the first external gear 14 (hereinafter, may be referred to as an “eccentricity amount adjustment structure”). Since the amount of eccentricity e2 is greater than the amount of eccentricity e1, the substantial oscillation amount of the second external gear 15 increases, and the clearance due to the deflection of the inner pin 48 can be offset to some extent. As a result, the torque share of the second external gear 15 increases, the torque share of the first external gear 14 decreases, and the influence on the sliding portions of these gears can be made to be close to equal.

From the viewpoint of expanding applications, it is desirable for the gear device to be reduced in size and weight. Therefore, in the gear device 100 according to the embodiment, the inner pins 48 are cantilever-supported by the carrier 35 in order to reduce size and weight. Since the inner pin 48 is more likely to deflect in the cantilever support than in the both-end support, the effect of reducing the influence on the sliding portion by the eccentricity amount adjustment structure of the present disclosure is easily exhibited. The inner pin 48 may be supported at both ends.

The means for making the amount of eccentricity e2 greater than the amount of eccentricity e1 is not limited, and various means can be adopted. Hereinafter, examples of the means for making the amount of eccentricity e2 greater than the amount of eccentricity e1 will be described.

(1) The amount of eccentricity of the eccentric portion 25 is made greater than the amount of eccentricity of the eccentric portion 24. In this case, the amount of eccentricity e2 can be made greater than the amount of eccentricity e1.

(2) The diameter D2 of the rolling element 52 of the eccentric-body bearing 18 is made greater than the diameter D1 of the rolling element 51 of the eccentric-body bearing 17. In this case, the amount of eccentricity e2 can be made greater than the amount of eccentricity e1.

(3) The above (1) and (2) are combined.

In the above (2), for example, an inner diameter 44 of the external gear 14 and an inner diameter 45 of the external gear 15 are the same as each other. In this case, since the diameter D2 of the rolling element 52 is greater than the diameter D1 of the rolling element 51, the gap between the rolling element 51 and the inner diameter 44 of the external gear 14 is greater than the gap between the rolling element 52 and the inner diameter 45 of the external gear 15. In this case, since the external gear 14 and the external gear 15 rotate to close the gap when the external gears 14 and 15 and the internal gear 16 mesh with each other, the rotation center line L1 of the external gear 14 is closer to the center axis of the internal gear than the rotation center line L2 of the external gear 15. Therefore, the amount of eccentricity e2 can be made greater than the amount of eccentricity e1.

In the above description, the case where the inner diameter 44 of the external gear 14 and the inner diameter 45 of the external gear 15 are the same has been described, but the present disclosure is not limited thereto, and the inner diameter 44 of the external gear 14 and the inner diameter 45 of the external gear 15 may be different from each other. In this case as well, the amount of eccentricity e2 can be made greater than the amount of eccentricity e1 as long as the gap between the rolling element 51 and the inner diameter 44 of the external gear 14 is greater than the gap between the rolling element 52 and the inner diameter 45 of the external gear 15.

The characteristics of the eccentric oscillation-type gear device 100 configured as described above will be described. The eccentric oscillation-type gear device 100 includes eccentric bodies 31 and 32, a first external gear 14 and a second external gear 15 that oscillate by predetermined amounts of eccentricity due to the eccentric bodies 31 and 32, a carrier 35 provided on an axially opposite side of the first external gear 14 from the second external gear 15, and a plurality of inner pins 48 integrated by the carrier 35 and passing through the first external gear 14 and the second external gear 15, in which an amount of eccentricity e2 of a second eccentric body 32 corresponding to the second external gear 15 is greater than an amount of eccentricity e1 of a first eccentric body 31 corresponding to the first external gear 14.

According to this configuration, even in a case where the deflection of the portion of the inner pin 48 farther from the carrier 35 is large, the amount of eccentricity e2 of the portion away from the carrier 35 is greater than the amount of eccentricity e1 of the portion closer to the carrier 35, so that the difference in the amount of oscillation between the external gears 14 and 15 is reduced by compensating for the difference in deflection. As a result, the difference in the torque share between these gears and the difference in the influence of the gears on each sliding portion, which is caused by the difference in the torque share, can be reduced.

As an example, the plurality of inner pins 48 are cantilever-supported by the carrier 35. In this case, since the member that supports the tip end side of the carrier 35 can be omitted, the number of components is reduced as compared with the both-end support, which is advantageous for reducing size and weight. Since the cantilever support is more likely to deflect than the both-end support, the effect of reducing the influence on each sliding portion of the gear by the eccentricity amount adjustment structure of the present disclosure is easily exhibited.

As an example, the eccentric bodies 31 and 32 respectively include eccentric portions 24 and 25 formed on an outer periphery of a shaft body, and eccentric-body bearings 17 and 18 disposed on an outer periphery of the eccentric portions 24 and 25, and an amount of eccentricity of the eccentric portion 25 of the second eccentric body 32 is greater than an amount of eccentricity of the eccentric portion 24 of the first eccentric body 31. In this case, by providing the difference in the amount of eccentricity of the eccentric portions 24 and 25, the difference in the amount of eccentricity of the eccentric bodies 31 and 32 can be easily set.

As an example, the eccentric bodies 31 and 32 respectively include eccentric portions 24 and 25 formed on an outer periphery of a shaft body and eccentric-body bearings 17 and 18 disposed on an outer periphery of the eccentric portions 24 and 25, and a diameter D2 of a rolling element 52 of the eccentric-body bearing 18 of the second eccentric body 32 is greater than a diameter D1 of a rolling element 51 of the eccentric-body bearing 17 of the first eccentric body 31. In this case, by providing the difference in the diameter of the rolling element of the eccentric-body bearings 17 and 18, the difference in the amount of eccentricity of the eccentric bodies 31 and 32 can be easily set.

The present disclosure has been described above based on the embodiments. These embodiments are merely examples, and it is understood by those skilled in the art that various modifications and changes can be made, and such modifications and changes are also included in the scope of the present disclosure. Therefore, the descriptions and the drawings in the present specification should be treated as illustrative, rather than limiting.

### MODIFICATION EXAMPLES

Hereinafter, modification examples will be described. In the drawings and description of the modification examples, identical or equivalent components and members to those of the embodiment are denoted by the same reference numerals. Description overlapping with that of the embodiment will be omitted as appropriate, and configurations different from those of the embodiment will be described in detail.

In the description of the embodiment, the amount of eccentricity e2 is made greater than the amount of eccentricity e1 by (1) making the amount of eccentricity of the eccentric portion 25 greater than the amount of eccentricity of the eccentric portion 24, (2) making the diameter D2 of the rolling element 52 of the eccentric-body bearing 18 greater than the diameter D1 of the rolling element 51 of the eccentric-body bearing 17, or (3) combining (1) and (2), but the present disclosure is not necessarily limited thereto. For example, in the description of the embodiment, the example in which a wall thickness (a wall thickness between an inner peripheral surface and an outer peripheral surface) of the inner roller 49 is constant in the axial direction has been described, but the amount of eccentricity e2 can also be made greater than the amount of eccentricity e1 by making a wall thickness of a portion of the inner roller 49 in contact with the second external gear 15 greater than a wall thickness of a portion of the inner roller 49 in contact with the first external gear 14.

In the description of the embodiment, an example in which the axial lengths T1 and T2 of the rolling elements 51 and 52 of the eccentric-body bearings 17 and 18 are the same has been described, but the present disclosure is not limited thereto. The axial lengths T1 and T2 may be different from each other. For example, the axial length T2 of the rolling element 52 of the second eccentric-body bearing 18 may be greater than the axial length T1 of the rolling element 51 of the first eccentric-body bearing 17.

In the description of the embodiment, the example in which the internal gear 16 is constituted by internal teeth integrally formed on an inner periphery of the casing has been described, but the present disclosure is not limited thereto. The internal gear may be constituted by cylindrical pin members rotatably supported in pin grooves provided on the inner periphery of the casing.

In the description of the embodiment, the example in which the gear device 100 includes two external gears 14 and 15 has been shown, but the present disclosure is not limited thereto. The gear device may include three or more external gears.

In the description of the embodiment, the example in which the output rotation is output from the output flange 36 connected to the output side of the carrier 35 has been described, but the present disclosure is not limited thereto. It is not essential to include the output flange, and the output rotation may be output from the carrier. Further, the output rotation may be output from the casing 61 and 62 side with the output flange 36 side as the fixed side.

In the description of the embodiment, the example in which the main bearing 37 is a cross-roller bearing has been described, but the present disclosure is not limited thereto. The main bearing may be a bearing of a different type from the cross-roller bearing, such as a pair of angular-ball bearings or an angular-roller bearing.

In the description of the embodiment, the example in which the crankshaft bearings 39 and 40 are ball bearings has been described, but the present disclosure is not limited thereto. The crankshaft bearing may be a bearing of a different type from the ball bearing, such as a roller bearing.

In the description of the embodiment, the example in which the gear device 100 is a so-called center crank-type eccentric oscillation-type gear device has been described, but the present disclosure is not limited thereto. For example, the gear device may be a so-called distributing-type eccentric oscillation-type gear device in which a plurality of crankshafts are provided at positions offset from the center axis of the internal gear.

Each of these modification examples exhibits the same operations and effects as those of the embodiment.

Any combination of the above embodiments and modification examples is also useful as an embodiment of the present disclosure. A new embodiment resulting from such a combination has the combined effects of the respective embodiments and modification examples that are combined.

The present disclosure relates to an eccentric oscillation-type gear device.

It should be understood that the invention is not limited to the above-described embodiment, but may be modified into various forms on the basis of the spirit of the invention. Additionally, the modifications are included in the scope of the invention.

What is claimed is:

1. An eccentric oscillation-type gear device comprising:
eccentric bodies;
a first external gear and a second external gear that oscillate by predetermined amounts of eccentricity due to the eccentric bodies;
a carrier provided on an axially opposite side of the first external gear from the second external gear; and
a plurality of inner pins integrated by the carrier and passing through the first external gear and the second external gear,
wherein an amount of eccentricity of a second eccentric body corresponding to the second external gear is greater than an amount of eccentricity of a first eccentric body corresponding to the first external gear.

2. The eccentric oscillation-type gear device according to claim 1,
wherein the plurality of inner pins are cantilever-supported by the carrier.

3. The eccentric oscillation-type gear device according to claim 1,
wherein the eccentric bodies each include an eccentric portion formed on an outer periphery of a shaft body, and an eccentric-body bearing disposed on an outer periphery of the eccentric portion, and
an amount of eccentricity of the eccentric portion of the second eccentric body is greater than an amount of eccentricity of the eccentric portion of the first eccentric body.

4. The eccentric oscillation-type gear device according to claim 1,
wherein the eccentric bodies each include an eccentric portion formed on an outer periphery of a shaft body, and an eccentric-body bearing disposed on an outer periphery of the eccentric portion, and
a diameter of a rolling element of the eccentric-body bearing of the second eccentric body is greater than a diameter of a rolling element of the eccentric-body bearing of the first eccentric body.

5. The eccentric oscillation-type gear device according to claim 2,
wherein a cylindrical inner roller is disposed on an outer periphery of each of the plurality of inner pins.

6. The eccentric oscillation-type gear device according to claim 5,
wherein a wall thickness of a portion of the inner roller in contact with the second external gear is greater than a wall thickness of a portion of the inner roller in contact with the first external gear.

7. The eccentric oscillation-type gear device according to claim 5,
wherein the plurality of inner pins are integrally formed with the carrier.

8. The eccentric oscillation-type gear device according to claim 5,
wherein the plurality of inner pins are formed separately from the carrier and are connected to the carrier.

9. The eccentric oscillation-type gear device according to claim 5,
wherein tip ends of the plurality of inner pins face an end washer in a state of being in contact with or not in contact with the end washer.

10. The eccentric oscillation-type gear device according to claim 1,
wherein an axial length of a rolling element of an eccentric-body bearing of the second eccentric body is greater than an axial length of a rolling element of an eccentric-body bearing of the first eccentric body.
